(19) United States
(12) Patent Application Publication
(10) Pub. No.: US 2006/0184528 A1
(43) Pub. Date: Aug. 17, 2006

(54) Distributed database with device-served leases

(75) Inventor: Ohad Rodeh, Tel Aviv-Jaffa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/057,464

(22) Filed: Feb. 14, 2005

(51) Int. Cl. G06F 17/30

(52) U.S. Cl. 707/8

(57) ABSTRACT

A method for managing data in a computer system includes storing the data in a plurality of data structures. When a transaction request for accessing the data in a specified data structure is received, a time-limited lease on the specified data structure is granted responsively to the transaction request. Access to the specified data structure is controlled, based on the lease, until completion of the transaction request.

### FIELD OF THE INVENTION

The present invention relates generally to computer systems, and particularly to methods and systems for building and operating distributed databases in computer systems.

### BACKGROUND OF THE INVENTION

Distributed shared-disk databases, i.e., database systems that use multiple storage devices, are used in many computer systems. One example of such a product is DB2®, produced by IBM Corporation (Armonk, New-York). Additional details regarding DB2 products can be found at www-306.ibm.com/software/data/db2/. Another family of distributed shared-disk databases is produced by Oracle Corporation (Redwood Shores, Calif.). Additional details regarding Oracle database products can be found at www.oracle.com.

Several methods have been proposed for controlling the access of multiple transactions to shared storage devices. This sort of access is needed in distributed databases for maintaining data integrity and for recovering from node failures. For example, one such method is described by Mohan and Narang, in a paper entitled “Recovery and Coherency-Control Protocols for Fast Intersystem Page Transfer and Fine-Granularity Locking in a Shared Disks Transaction Environment,” Proceedings of the 17th International conference on Very Large Data Bases, Barcelona, Spain, September 1991, pages 193-207, which is incorporated herein by reference. The authors describe schemes for fast page transfers between transaction system instances wherein all sharing instances read and modify the same data. Recovery and coherency control schemes are also described.

Distributed databases sometimes use centralized clustering services, also called “group services,” for synchronizing the data that is distributed across the system. Examples of such group services are described in the publication “RS/6000 Cluster Technology Group Services Programming Guide and Reference,” IBM reference SA22-7355-02, IBM International Technical Support Organization, December 2001, which is available at www-1.ibm.com/support/docview.wss?uid=pub1sa22735502. Another distributed computer system comprising group services is described by Hayden in a PhD thesis entitled “The Ensemble System,” Computer Science Department Technical Report TR98-1662, Cornell University, Ithaca, N.Y., January 1998, which is incorporated herein by reference. The author describes a general-purpose group communication system called “Ensemble,” which can be used in constructing reliable distributed applications.

Accessing data by multiple users and performing fault recovery in databases is typically handled using locking and logging mechanisms. For example, the IBM DB2 database family uses a method called ARIES (Algorithm for Recovery and Isolation Exploiting Semantics). This method is described by Mohan et al. in a paper entitled “ARIES: a Transaction Recovery Method Supporting Fine-Granularity Locking and Partial Rollbacks using Write-Ahead Logging,” ACM Transactions on Database Systems, (17:1), March 1992, pages 94-162, which is incorporated herein by reference.

Some distributed database systems use object-disks (sometimes referred to as Object-based Storage Devices or OSDs) as building blocks. The Storage Network Industry Association (SNIA) handles the standardization of OSDs and their interfaces. Additional information regarding object-disks can be found at www.snia.org/tech_activities/workgroups/osd. Rodeh and Teperman describe a decentralized file system that uses locking and logging methods for accessing OSDs in a paper entitled “zFS—A Scalable Distributed File System Using Object-Disks, 20^{th} IEEE/11^{th} NASA Goddard Conference on Mass Storage Systems and Technologies (MSS'03), San Diego, Calif., April 2003, which is incorporated herein by reference.

### SUMMARY OF THE INVENTION

As mentioned above, currently-available methods for managing distributed databases typically use clustering or group services. While such global services support the synchronization of data and failure recovery, they also suffer from several inherent disadvantages. For example, deploying group services typically requires an additional software layer with software components running on the computers in the network and dedicated messaging protocols between these software components. The amount of messaging traffic associated with group services grows rapidly with the size of the computer system, making it difficult to provide scalable solutions that are suitable for large clusters.

In response to the shortcomings of the prior art, disclosed embodiments of the present invention provide methods and systems for building and operating a database that is truly distributed, in the sense that synchronization and integrity of distributed data are maintained without reliance on centralized clustering or group services. As will be explained hereinbelow, distribution of the data integrity and access control functions is accomplished by a novel method of issuing device-served leases, or time-limited access permissions, that are granted by the nodes and storage devices of the computer system. The distribution of these leasing functions permits new storage devices and compute-nodes that are added to the system to take on their share of these functions, so that the computing and I/O load is spread throughout the system. The disclosed system configuration is thus highly scalable and robust in handling compute-node failures.

Some embodiments of the present invention provide novel methods for rolling-back of failed or aborted database transactions, as well as methods for recovering from various failure events in a distributed database.

Although features of the present invention are particularly suited for supporting database applications, the principles of the present invention are applicable in distributed storage systems generally, in support of distributed applications of other kinds.

There is therefore provided, in accordance with an embodiment of the present invention, a method for managing data in a computer system, including:

storing the data in a plurality of data structures;

receiving a transaction request for accessing the data in a specified data structure;

granting a time-limited lease on the specified data structure responsively to the transaction request; and

controlling an access to the specified data structure based on the lease until completion of the transaction request.

In an embodiment, the data structures are stored on object-disks, and granting the time-limited lease includes granting a major lease from one of the object-disks on which the specified data structure is stored to a compute-node handling the transaction request.

In another embodiment, granting the lease includes granting the lease to a first compute-node in the computer system and delegating the lease from the first compute-node to a second compute-node in the computer system.

In yet another embodiment, granting the lease includes granting a lease for accessing a storage device on which the specified data structure is stored, and wherein controlling the access includes issuing at least one lock for accessing data objects stored in the storage device. Additionally, the at least one lock is released upon expiration of the lease.

In still another embodiment, issuing the at least one lock includes appointing a compute-node in the computer system to serve as a lock manager for the storage device, wherein the lock manager issues the at least one lock.

In another embodiment, the at least one lock is maintained by a first compute-node in the computer system, and controlling the access includes restoring the at least one lock responsively to a failure in the first compute-node using a second compute-node in the computer system.

In yet another embodiment, controlling the access includes:

recording transaction entries in one or more log objects stored in one or more of data structures;

accessing the data objects responsively to the transaction entries; and

marking the transaction entries and the respective data objects with log serial numbers (LSNs), so as to cause each data object to be marked with monotonically-increasing LSNs. Additionally, when the transaction request is not completed, the transaction request is rolled-back using the transaction entries recorded in the one or more log objects, so as to remove effects of the transaction request from the plurality of data structures.

In another embodiment, controlling the access includes, responsively to a failure of a first compute-node handling the transaction request, completing the transaction request by a second compute-node using the transaction entries recorded in the one or more log objects.

There is also provided, in accordance with an embodiment of the present invention, a computer system including:

a first plurality of storage devices, which are arranged to store data in data structures; and

a second plurality of compute-nodes, which are arranged to receive a transaction request for accessing the data in a specified data structure, and responsively to the transaction request, to request and receive a time-limited lease on the specified data structure, and to control an access to the specified data structure based on the lease until completion of the transaction request.

There is additionally provided, in accordance with an embodiment of the present invention, a computer software product including a computer-readable medium in which program instructions are stored, which instructions, when read by one or more computers, cause the one or more computers to store data in data structures, to receive a transaction request for accessing the data in a specified data structure, and responsively to the transaction request, to request and receive a time-limited lease on the specified data structure, and to control an access to the specified data structure based on the lease until completion of the transaction request.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer system, in accordance with an embodiment of the present invention;

FIG. 2 is a flow chart that schematically illustrates a method for lease delegation, in accordance with an embodiment of the present invention;

FIG. 3 is a flow chart that schematically illustrates a method for page locking, in accordance with an embodiment of the present invention;

FIGS. 4A-4C are diagrams that schematically illustrate transaction log entries, in accordance with an embodiment of the present invention;

FIG. 5 is a flow chart that schematically illustrates a method for performing a transaction, in accordance with an embodiment of the present invention;

FIG. 6 is a flow chart that schematically illustrates a method for transaction rollback, in accordance with an embodiment of the present invention; and

FIG. 7 is a flow chart that schematically illustrates a method for compute-node recovery, in accordance with an embodiment of the present invention.

### DETAILED DESCRIPTION OF EMBODIMENTS

### System Description

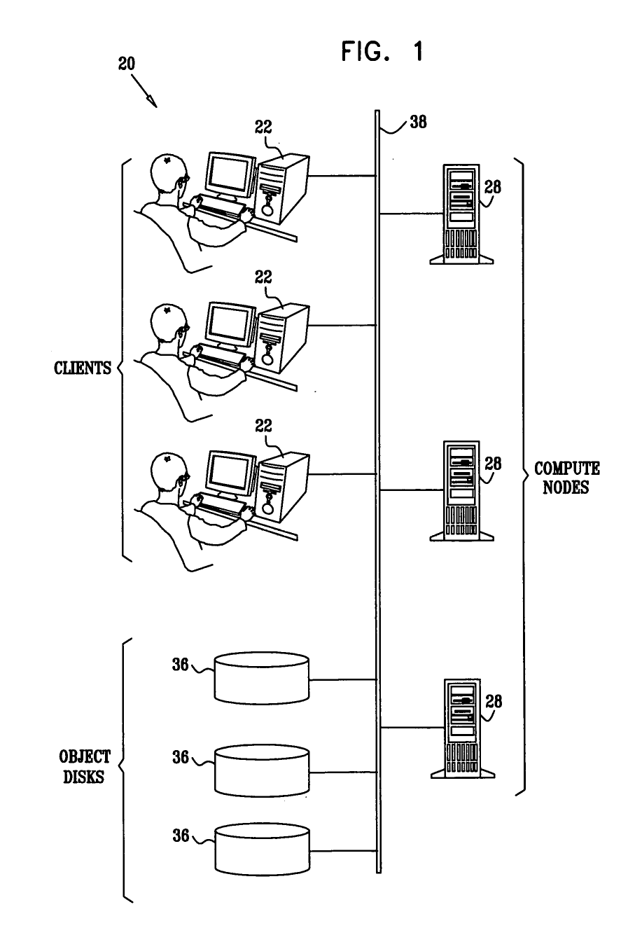

FIG. 1 is a block diagram that schematically illustrates a computer system 20, in accordance with an embodiment of the present invention. System 20 comprises clients 22, compute-nodes 28 and storage devices, such as object-disks 36. Clients 22 typically comprise computers or workstations operated by users of system 20. Clients 22 may use a variety of applications that require storing, retrieving and modifying the data stored in object-disks 36. Compute-nodes 28 typically comprise servers that operate the various software applications of system 20 and perform various database manipulation functions, according to methods described below. Manipulation of the data stored in object-disks 36 is typically expressed in terms of transactions, or transaction requests, issued by the clients and carried out by the compute-nodes.

Each object-disk 36 is a logical storage device, typically comprising a physical storage device, such as a disk, for storing objects (files) and an application interface (API) that communicates with other components of the computer system and enables creation, modification and deletion of objects. In other words, the object-disks and objects can be regarded as data structures, and the methods described herein may also be applied to other types of data structures. The clients, compute-nodes and object-disks are typically interconnected using a suitable high-speed data network 38. An object-disk is also referred to as an object-based storage device (OSD). Although the OSD model is advantageous in building distributed databases, the principles of the present invention may also be applied, mutatis mutandis, using storage devices of other kinds, such as conventional disks or NAS (Network Attached Storage) devices.

The configuration of system 20 and the methods described below were particularly developed to support large-scale computer systems, on the order of hundreds of nodes or more. As will be apparent to those skilled in the art, eliminating clustering and group services is particularly beneficial in large-scale computer systems. Nevertheless, the system configuration described below is highly scalable by nature and may be used for any number of clients, compute-nodes and object-disks.

The clients and compute-nodes, as well as components of the object-disks, may be implemented using general-purpose computers, which are programmed in software to carry out the functions described herein. The software may be downloaded to the computers in electronic form, over a network, for example, or it may alternatively be supplied to the computers on tangible media, such as CD-ROM. The clients, compute-nodes and object-disks may comprise standalone units, or they may alternatively be integrated with other computing functions of computer system 20. Alternatively, functions carried out by the clients, compute-nodes and object-disks may be distributed differently among components of the computer system.

### Device-Served Leases

Device-served leases are fundamental building blocks of the methods described hereinbelow. A lease is a lock on a resource, such as an object-disk or on an individual page, having a predetermined expiration period. A lease can be viewed as a “virtual token,” allowing exclusive permission to access a resource, obtained by a compute-node for a limited time period. A typical expiry period used by the inventor is on the order of 30 seconds. A compute-node that wishes to maintain its access permission must periodically renew its lease. If the lease-holder does not renew the lease (due to compute-node failure, for example), the OSD automatically becomes available for major lease (i.e., a lease on the entire OSD, rather than on a specific object) to other compute-nodes without requirement for further communication among the nodes.

Leases are useful in environments in which compute-nodes may fail. When a compute-node holding a lease for a particular resource fails, another compute-node may gain access to the resource after the lease expires, without the need for any additional exchange of information or synchronization. If the failed compute-node recovers, it will have to re-obtain the lease in order to access the resource again. Using leases thus enables multiple users to access a resource without any centralized clustering or group services. The term “device-served” emphasizes the fact that the leases are issued and managed by the resources themselves and not by any centralized service.

Each OSD 36 supports a single exclusive lease, denoted “major-lease.” Only the holder of a valid (i.e., non-expired) major-lease has permission to access that particular OSD. Each OSD also maintains a record as to the identity of the compute-node that currently holds its major-lease. If a compute-node requests access to an OSD, the OSD will provide the requesting node with the network address of the major-lease holder. Typically, three operations are defined for a compute-node with regards to the major-lease of an OSD: take, release and renew. Leases may also be delegated from one compute-node to another, as shown below.

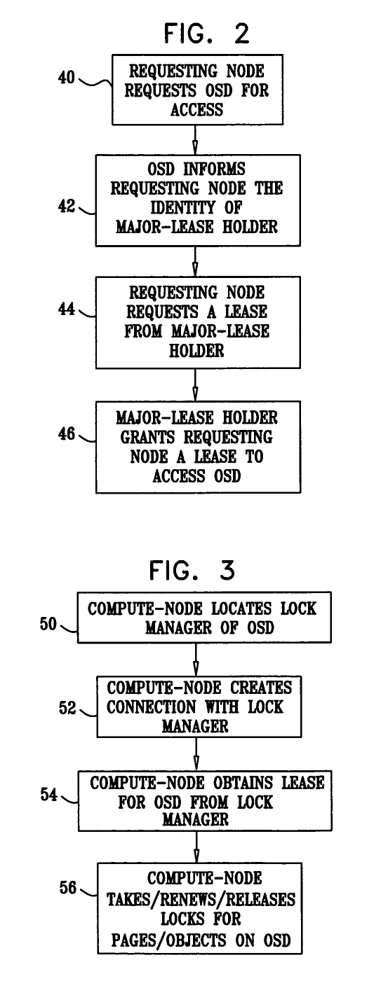

FIG. 2 is a flow chart that schematically illustrates a method for lease delegation, in accordance with an embodiment of the present invention. The method begins when a compute-node 28, denoted B, wishes to access an OSD 36, which has already issued its major-lease to another compute-node 28, denoted A. Compute-node B (the “requesting node”) contacts the OSD and requests a lease, at a lease requesting step 40. The OSD informs compute-node B that its major-lease is already issued to compute-node A, at a notification step 42. Compute-node B contacts compute-node A, the major-lease holder, and requests access to the OSD at a delegation requesting step 44. Compute-node A may grant the request and issue compute-node B a lease (having its own expiry period) to access the OSD, at a delegation step 46. Compute-node B now has an exclusive permission to access the OSD until the lease expires. If compute-node B wishes to continue accessing the OSD it should continuously renew its lease from compute-node A, the major-lease holder.

### Page Locking

A typical database transaction carried out by a compute-node comprises the modification of data on one or more pages belonging to one or more files (objects). The files or objects may be stored on a single OSD or distributed among several OSDs. Before accessing and modifying data in a particular page, a compute-node 28 should first obtain a lock on the required page, to avoid conflicts with other compute-nodes that may try to modify the same page at the same time. For this purpose, each OSD 36, denoted X, in system 20 supports a lock manager, denoted X_{LKM}, which provides lock services for all pages stored on OSD X to all components of system 20. Lock manager X_{LKM} may run on any compute-node in system 20. The lock manager typically operates by taking the major-lease for OSD X and continuously renewing it.

FIG. 3 is a flow chart that schematically illustrates a method for page locking, in accordance with an embodiment of the present invention. The method begins when a compute-node 28, operating on behalf of an application run by a client 22, asks to take a lock on a page (or other object) on OSD X. The compute-node first locates X_{LKM}, the lock manager of OSD X, by querying OSD X for the location of its lock manager, at a location step 50. The compute-node creates a connection with the lock manager at a connection step 52. The connection may comprise a TCP network connection, or any other suitable connection, over which protocol messages may be passed reliably. AS long as this connection is maintained, there is no need for further lookup requests between the compute-node and the OSD. Through this protocol, the lock manager issues the compute-node a major-lease on the OSD, at a lease issuing step 54.

Subject to the major-lease, the compute-node subsequently takes, renews and releases locks on pages and other objects on the OSD, as required by the transaction it needs to perform, at a locking step 56. The locks enable the compute-node to modify the data and perform the transaction. In other words, both the major-lease and a specific lock on the target page or object are needed in order to perform a transaction on the target.

The lease given by the lock manager to the compute-node is thus different from the major-lease, as it protects the client-server protocol between the lock taker (the compute-node) and the lock manager. As with all leases, the compute-node should periodically renew its lease with the lock manager. As long as this lease is valid, all of the client's locks on pages and objects will be respected. If the compute-node does not renew its lease, the lock manager will assume the compute-node failed. When the lease has expired, the lock manager will notify any node that asks to access pages previously locked by the failed node that recovery needs to be performed (see the detailed description of recovery methods hereinbelow). A compute-node that was disconnected, for any reason, from the lock manager will not be able to re-connect until its lease has expired.

Compute-nodes that have obtained leases from a lock manager are then allowed direct access to the respective OSD. This provision enhances efficiency of storage access but assumes that the compute-nodes are non-malicious, i.e., that they will modify only pages that they have previously locked.

In practical implementations, the lock manager itself may also fail. Several methods may be used for maintaining and respecting the locks granted by a lock manager that failed. In one embodiment, all granted locks may be recorded to disk (“hardened”) by setting up an object denoted X_{locks} on OSD X, comprising a list of all locks currently granted by X_{LKM}. X_{locks} is updated whenever a lock is granted or released. Access to X_{locks} is available only to X_{LKM}, as it holds the major-lease for OSD x. Should the compute-node running X_{LKM} fail, another compute-node will typically take the major-lease for OSD X and recover the locks from X_{locks}.

In a distributed database, deadlock situations may occur in spite of the locking methods used. For example, consider a scenario in which two compute-nodes labeled A and B simultaneously request locks on two pages labeled P1 and P2, but in reverse order. The result is that compute-node A will take a lock on P1 and will be denied access to P2, while compute-node B will take a lock on P2 but will be denied access to P1. Both transactions will be stuck, waiting endlessly to receive a lock on their respective second pages. Practical deadlock scenarios are typically more complex and may involve several compute-nodes.

The deadlock problem is particularly severe in distributed databases that have no global lock manager having complete knowledge of the locks that have been taken and requested across the system. Several methods are known in the art for resolving deadlock situations such as the scenario described above. Such methods typically involve identifying transactions that block each other and breaking the deadlock by aborting some of these transactions. Any suitable deadlock prevention method may be used in conjunction with the methods described herein.

In the description above, pages are treated as the atomic unit for locking. A page (typically on the order of 8K bytes in size) may comprise multiple records, and database applications typically require record-level read/write locking. Therefore, in one embodiment, a compute-node that takes a lock on a page using the methods described hereinabove may provide finer locking granularity by locking individual records within this page for particular transactions running on this compute-node. Additional information regarding page locking methods may also be found in the paper by Rodeh and Teperman cited above.

### Transaction Logging

A database is often required to perform rollback of a transaction, either because the transaction is aborted by the user or as part of recovery from a failure. To support rollback and recovery from failures, each compute-node 28 typically maintains a log object that records all database transactions. One logging technique that may be used for this purpose is Write-Ahead Logging (WAL). WAL means that each entry of a transaction is recorded in the log before being performed in the database itself. Once all entries of a particular transaction have been logged and performed, the transaction is committed to disk. This technique enables transactions to be recovered and “re-played” in the event of a failure.

Every log entry is typically stamped with a Log Sequence Number (LSN) provided by the log. The LSNs are assigned to pages in a monotonically increasing order. Each modified page in the database is stamped with the largest LSN of a log entry that modified it. The compute-node keeps track of the largest LSN entry that was committed to disk, and prevents pages having larger LSNs from being written to the disk. A method for synchronizing LSNs when multiple log objects are present is described below.

The WAL logging scheme described above is similar to the one used by ARIES (as described in the paper by Mohan et al. cited above). Other logging schemes are known in the art. The methods described below may also be used in conjunction with any other suitable logging scheme.

Before describing the methods in which database transactions are performed in system 20, certain aspects of log management will be demonstrated and explained in greater detail.

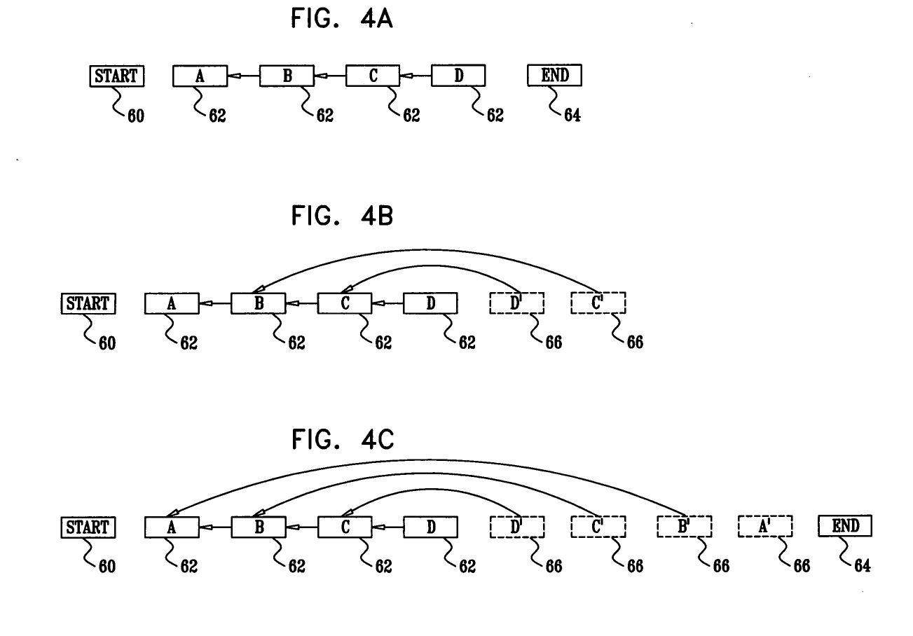

FIGS. 4A-4C are diagrams that schematically illustrate three stages in the process of managing log entries of a transaction using WAL, in accordance with an embodiment of the present invention. FIGS. 4A-4C show an exemplary sequence of events, in which a transaction is aborted during execution and then recovered. Recovery is interrupted due to failure of a compute-node and is then performed again by another compute-node.

FIG. 4A shows a log object comprising an “open transaction” or “start” entry 60, followed by four transaction entries 62 labeled A, B, C and D. The log ends with a “close transaction” or “end” entry 64. Transaction entries 62 are backward-chained, as indicated by the arrows in FIG. 4A. The presence of end entry 64 indicates that the transaction has been logged and committed successfully.

FIG. 4B shows a log object in the process of aborting the transaction that is shown in FIG. 4A. Aborting may be performed because of a user directive or because of a compute-node failure. The transaction is aborted by performing the corresponding chain of transaction entries 62 in undo mode (i.e., undoing each transaction entry 62, starting from the most recent entry and following the backward-chained entries to the beginning of the transaction). With each transaction entry 62 that is undone, a Compensation Log Record (CLR) 66 is added to the end of the log. Each newly-added CLR is given an LSN, and the corresponding modified page is stamped with the same LSN. The undone page may be written to disk only after the corresponding CLR has been written to disk.

As can be seen in the example of FIG. 4B, two transaction entries 62, labeled C and D, have been undone. Corresponding CLRs 66, labeled C′ and D′ (drawn as dashed blocks), have been added to the log to compensate for transaction entries C and D. Each CLR is chained to the transaction entry previous to the one it is undoing. (In the example of FIG. 4B, CLR C′ points to transaction entry B, and CLR D′ points to transaction entry C.) This CLR configuration is useful for scenarios in which recovery is interrupted due to a failure and needs to be performed again.

FIG. 4C shows the state of the log described in FIG. 4B, assuming that recovery was stopped after adding CLRs C′ and D′ because of compute-node failure, then restarted by another compute-node. The compute-node that performs the repeated recovery finds the log in the state shown by FIG. 4B above, and is able to continue the undoing process from the point at which it was interrupted, subsequently adding CLRs B′ and A′ and end transaction 64, as shown in FIG. 4C. Once recovery is completed, the log has the structure shown in FIG. 4C. At this stage the transaction has been fully aborted. The database returned to the exact state it had before the transaction started, regardless of the interruptions and failures that occurred during the recovery process.

### Transaction Processing

Having explained the principles of log management, the nominal transaction process in system 20 will now be explained and demonstrated.

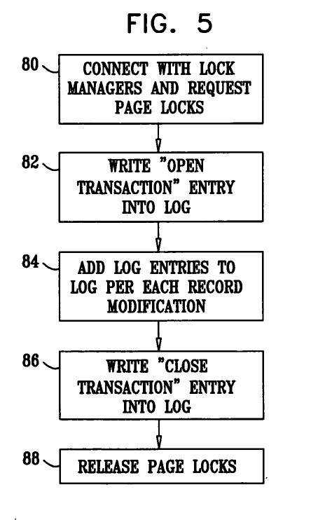

FIG. 5 is a flow chart that schematically illustrates a method for performing a transaction in system 20, in accordance with an embodiment of the present invention. The example of FIG. 5 begins when a compute-node 28, denoted A, handles a request to perform a transaction comprising a sequence of record modifications. The records are assumed to belong to pages stored in two different OSDs 36, labeled X and Y. (Other practical scenarios may comprise pages stored in one or any number of OSDs.) Compute-node A first contacts X_{LKM} and Y_{LKM}, the lock managers of OSDs X and Y, and requests locks on the required pages, at a lock requesting step 80. The compute-node writes an “open transaction” entry into log_{A} (the log object of compute-node A, which may be located on any OSD 36), at a transaction opening step 82. The compute-node then adds log entries into log_{A} for each record modification, at a logging step 84. When finished, the compute-node writes a “close transaction” entry into log_{A}, at a transaction closing step 86, and the modified page is then written to disk. Compute-node A then releases the page locks at a lock releasing step 88. Compute-node A may choose not to release the page locks as long as other compute-nodes do not request them. Keeping the locks may simplify subsequent transaction processing, since each page is then written to disk only once—before the lock is finally released (“write-back caching”). Modifies pages are written to disk prior to releasing the page locks. Releasing a page lock before the page has been written to disk may cause an inconsistency in the database.

### LSN Management

Computer system 20 typically comprises multiple compute-nodes and therefore also comprises multiple respective log objects, one log object for each compute-node. As described above, each log object stamps modified pages with monotonically increasing LSNs (Log Sequence Numbers). To maintain data integrity and avoid erroneous recovery attempts, the LSNs assigned by different log objects should be mutually synchronized so that each page is stamped with a single LSN. Consecutive modifications to a certain page should be assigned monotonically increasing LSNs, even though they may be carried out by different compute-nodes and logged in different logs.

The following exemplary sequence of events demonstrates the potential errors that may occur in the absence of LSN synchronization between log objects:
Compute-node A takes a page lock on a page P and modifies it.
The log object of compute-node A stamps page P with an LSN value of 10. Compute-node A writes the page to disk and releases the page lock.
Compute-node B takes the page lock for page P and modifies it. The log object of compute-node B, which in this example assigns LSNs without any synchronization to the log object of compute-node A, stamps page P with an LSN value 6 (which happens to be lower than the previous LSN assigned to page P by the log object of compute-node A).
Compute-node B writes page P to disk and releases the page lock.

Following this sequence of events, if compute-node A ever takes the page lock on page P again, and then fails and recovers, it will find an LSN value 6 marking page P. Compute-node A will then redo the modification corresponding to LSN value 10, erroneously assuming that this modification was not yet written to disk. Since in ARIES replaying an entry twice is erroneous, redoing this modification results in an error.

In one embodiment, in order to maintain monotonically increasing LSNs, a compute-node modifying a page P first reads from page P the LSN that was previously assigned to it (denoted P_{LSN}). The compute-node then sets the LSN of its log to the maximum value between the current LSN of the compute-node and the P_{LSN} extracted from page P. This method ensures that LSNs will always be assigned in a monotonically increasing order. Alternatively, other LSN synchronization methods may be used for this purpose, as will be apparent to those skilled in the art, and any other suitable method may be used. Caution should be exercised when defining LSN synchronization methods, as some commercial database products encode into the LSN additional information, such as the location of the corresponding transaction entry in the log. In this case the LSN format may be extended to contain the additional information.

### Transaction Rollback

Rolling back a database transaction (i.e., canceling the transaction and restoring the database to the exact state it was in before the transaction) is needed when a user decides to abort a transaction. Rollback may also be required in the event of a deadlock between two or more transactions, as described above.

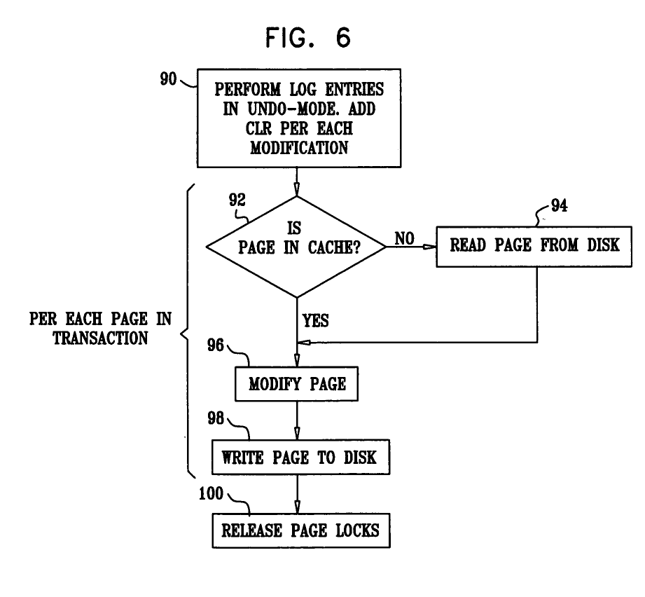

FIG. 6 is a flow chart that schematically illustrates a method for transaction rollback, in accordance with an embodiment of the present invention. The method begins at a stage in which a compute-node 28 denoted A is in the process of performing a transaction T. Compute-node A is assumed to hold a set of page locks on the set of modified pages of the transaction, as well as a lock on log_{A}. To roll back transaction T, compute-node A performs the set of log entries for transaction T in undo mode, and adds a CLR to log_{A} for each modification, at an undoing step 90. (For a detailed description of the logging method during rollback, see the description of FIGS. 4A-4C above.)

For each modified page that participates in transaction T, compute-node A checks whether the page is cached in memory, at a cache checking step 92. If not, the corresponding page is read from disk at a disk retrieval step 94. The compute-node modifies the page at a modifying step 96 and writes the page to disk at a writing step 98. As mentioned above, the compute-node performs steps 92-98 for all pages that require modification in transaction T.

Finally, compute-node A releases all page locks and terminates the rollback procedure, at a lock releasing step 100. At this stage transaction T is fully rolled-back. Note that deadlocks cannot occur during rollback since compute-node A already holds all relevant page locks from the beginning of transaction T.

### Fault Recovery

Several fault recovery scenarios are considered below for system 20:

### Recovery from Compute-Node Failures

In the event that compute-node denoted A fails and later recovers, compute-node A should replay log_{A} in order to restore the database to its state before the failure.

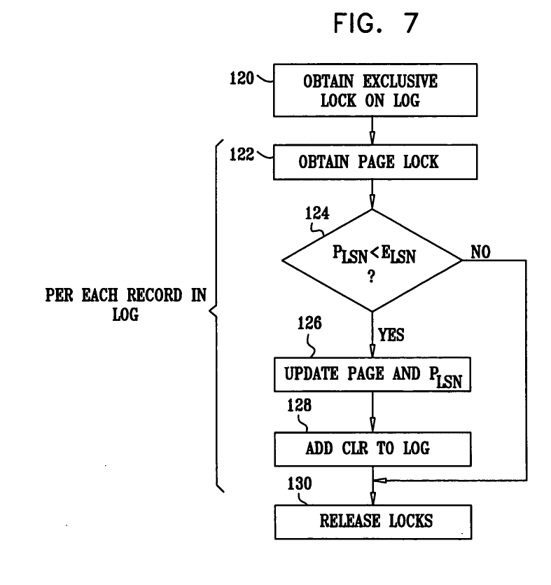

FIG. 7 is a flow chart that schematically illustrates a method for compute-node recovery, in accordance with an embodiment of the present invention. The method begins with compute-node A obtaining the exclusive lock on log_{A}, at a log locking step 120. The compute-node then performs a redo pass followed by an undo pass for each transaction entry 62, as shown below.

For each entry 62, denoted E, in log_{A}, compute-node A takes a page lock for the corresponding page P modified by the transaction entry, at a page locking step 122. The compute-node then checks whether P_{LSN} (the LSN of page P) is lower than E_{LSN} (the LSN of transaction entry E), at a LSN checking step 124. If indeed P_{LSN}<E_{LSN}, the compute-node updates page P and also updates P_{LSN}, at a page updating step 126. Otherwise, no page update is performed for this page. CLRs 66 are added to log_{A} for each modification at a CLR adding step 128. Steps 122-128 are performed by compute-node A for each transaction entry 62 in log_{A}. Finally, compute-node A releases all page locks at a lock releasing step 130.

As mentioned hereinabove, the lock-manager of a particular OSD grants locks to compute-nodes for pages that have previously been locked by a failed compute-node only after the failed-node lease expires. In one embodiment, after expiration of the lease on a given page, the lock manager gives the next node requesting a lock on the page the task of recovering the page, or even the entire transaction, prior to being granted the requested lock. The lock manager provides the requesting node with the name and location of the failed-node log object. This assignment of responsibility is required since there is no global service that is responsible for performing recovery.

In the event that a compute-node fails and does not recover, other compute-nodes may wait endlessly for its transactions to complete. This is a problem in a distributed environment because nodes occasionally become disconnected, slow, or suffer from slow network connections. To solve this problem, compute-node A may replay the log of another compute-node B if the latter loses the lock for log_{B}. Recovery of log_{B} by node A is similar to the recovery by the owner node, as described above with reference to FIGS. 4A-4C. Compute-node A typically performs the recovery of log_{B} while holding the exclusive lock to log_{B} so that it cannot be interrupted.

Following these methods ensures that once a transaction commit record is written to disk, the transaction is assured of succeeding. Even if the initiating compute-node fails, all modified records are still locked. The next compute-node that attempts to access any of these records will be requested to perform recovery on behalf of the failed compute-node. Following recovery, the transaction will be replayed from the initiator compute-node log.

### Recovery from Lock Manager Failures

When a compute-node fails, any lock manager running on the failed compute-node will also fail. If the lock-manager for OSD X fails, it cannot be replaced until the OSD lease it took expires. Connections between clients and failed lock-managers are torn down, and thus lock holders (clients) become aware that lock-manager recovery is about to take place.

In one embodiment, after the major-lease for OSD X (held by the failed compute-node) expires, another compute-node (for example, the next compute-node that requires access to a page stored in OSD X) takes the major-lease for OSD X and creates a new local lock manager X_{LKM}. The new X_{LKM} recovers the set of granted locks from object X_{locks} stored in OSD X. The new X_{LKM} pessimistically assumes that all lock-holders have also failed and notifies all lock-requesters for previously locked pages that recovery is required.

### Recovery from Multiple Failures

Multiple compute-node failures: As long as dependent transactions are not allowed, failure of several compute-nodes simply requires recovery of their separate logs. (A dependent transaction is a transaction that is allowed access to uncommitted records that are still being processed by another transaction.) The scheme described hereinabove requires each page to be written to disk before a lock on the page can be granted to any other compute-node. Therefore, for each page, there can be at most one log object with entries that have not yet been committed and written to disk.
Multiple lock-manager failures: As there are no inter-dependencies between lock-managers, recovery comprises recovering each lock-manager separately.
Multiple compute-node and lock-manager failures: As compute-nodes depend on the services of the lock-managers, the lock-managers need to be recovered first.

Although the leasing, locking and logging methods described herein mainly address OSDs and pages, these methods may be implemented using other data structures, such as disks and individual records. It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for managing data in a computer system, comprising:
storing the data in a plurality of data structures;
receiving a transaction request for accessing the data in a specified data structure;
granting a time-limited lease on the specified data structure responsively to the transaction request; and
controlling an access to the specified data structure based on the lease until completion of the transaction request.

2. The method according to claim 1, wherein the data structures are stored on object-disks, and wherein granting the time-limited lease comprises granting a major lease from one of the object-disks on which the specified data structure is stored to a compute-node handling the transaction request.

3. The method according to claim 1, wherein granting the lease comprises granting the lease to a first compute-node in the computer system and delegating the lease from the first compute-node to a second compute-node in the computer system.

4. The method according to claim 1, wherein granting the lease comprises granting a lease for accessing a storage device on which the specified data structure is stored, and wherein controlling the access comprises issuing at least one lock for accessing data objects stored in the storage device.

5. The method according to claim 4, and comprising releasing the at least one lock upon expiration of the lease.

6. The method according to claim 4, wherein issuing the at least one lock comprises appointing a compute-node in the computer system to serve as a lock manager for the storage device, wherein the lock manager issues the at least one lock.

7. The method according to claim 4, wherein the at least one lock is maintained by a first compute-node in the computer system, and wherein controlling the access comprises restoring the at least one lock responsively to a failure in the first compute-node using a second compute-node in the computer system.

8. The method according to claim 4, wherein controlling the access comprises:
recording transaction entries in one or more log objects stored in one or more of data structures;
accessing the data objects responsively to the transaction entries; and
marking the transaction entries and the respective data objects with log serial numbers (LSNs), so as to cause each data object to be marked with monotonically-increasing LSNs.

9. The method according to claim 8, and comprising, when the transaction request is not completed, rolling-back the transaction request using the transaction entries recorded in the one or more log objects, so as to remove effects of the transaction request from the plurality of data structures.

10. The method according to claim 8, wherein controlling the access comprises, responsively to a failure of a first compute-node handling the transaction request, completing the transaction request by a second compute-node using the transaction entries recorded in the one or more log objects.

11. A computer system comprising:
a first plurality of storage devices, which are arranged to store data in data structures; and
a second plurality of compute-nodes, which are arranged to receive a transaction request for accessing the data in a specified data structure, and responsively to the transaction request, to request and receive a time-limited lease on the specified data structure, and to control an access to the specified data structure based on the lease until completion of the transaction request.

12. The system according to claim 11, wherein the storage devices comprise object-disks, and wherein the compute-nodes are arranged to request and receive a major lease from one of the object-disks on which the specified data structure is stored in order to handle the transaction request.

13. The system according to claim 12, wherein the compute-nodes are arranged so that when a first compute-node has been granted the major lease, and a second compute-node is handling the transaction request, the second compute-node requests and receives a delegated lease from the second compute-node.

14. The system according to claim 11, wherein the compute-nodes are arranged to request and receive a lease for accessing a storage device on which the specified data structure is stored, and to request and receive at least one lock for accessing data objects stored in the storage device in order to handle the transaction request.

15. The system according to claim 14, wherein the compute-nodes are arranged to release the at least one lock upon expiration of the lease.

16. The system according to claim 14, wherein the compute-nodes are arranged so that one of the compute-nodes serves as a lock manager for the storage device, wherein the lock manager issues the at least one lock.

17. The system according to claim 14, wherein the compute-nodes are arranged so that responsively to a failure in a first compute-node handling the transaction request, a second compute-node restores the at least one lock.

18. The system according to claim 14, wherein the compute-nodes are arranged to record transaction entries in one or more log objects stored in one or more of the data structures, to access the data objects responsively to the transaction entries, and to mark the transaction entries and the respective data objects with log serial numbers (LSNs), so as to cause each data object to be marked with monotonically-increasing LSNs.

19. The system according to claim 18, wherein the compute-nodes are arranged to roll-back the transaction request using the transaction entries recorded in the one or more log objects when the transaction request is not completed, so as to remove effects of the transaction request from the data structures.

20. The system according to claim 18, wherein the compute nodes are arranged so that responsively to a failure of a first compute-node handling the transaction request, a second compute-node completes the transaction request using the transaction entries recorded in the one or more log objects.

21. A computer software product comprising a computer-readable medium in which program instructions are stored, which instructions, when read by one or more computers, cause the one or more computers to store data in data structures, to receive a transaction request for accessing the data in a specified data structure, and responsively to the transaction request, to request and receive a time-limited lease on the specified data structure, and to control an access to the specified data structure based on the lease until completion of the transaction request.

22. The product according to claim 21, wherein the data structures are stored on object-disks, and wherein the instructions cause one of the computers handling the transaction request to request and receive a major lease from one of the object-disks on which the specified data structure is stored.

23. The product according to claim 22, wherein, when a first computer has been granted the major lease, the instructions cause a second computer that is handling the transaction request to request and receive a delegated lease from the first computer.

24. The product according to claim 21, wherein the instructions cause one of the computers handling the transaction request to request and receive a lease for accessing a storage device on which the specified data structure is stored, and to request and receive at least one lock for accessing data objects stored in the storage device.

25. The product according to claim 24, wherein the instructions cause the at least one lock to be released upon expiration of the lease.

26. The product according to claim 24, wherein the instructions cause one of the computers to serve as a lock manager for the storage device, wherein the lock manager issues the at least one lock.

27. The product according to claim 24, wherein responsively to a failure in the one of the computers handling the transaction request, the instructions cause another one of the computers to restore the at least one lock.

28. The product according to claim 24, wherein the instructions cause the one or more computers to record transaction entries in one or more log objects stored in one or more of data structures, to access the data objects responsively to the transaction entries, and to mark the transaction entries and the respective data objects with log serial numbers (LSNs), so as to cause each data object to be marked with monotonically-increasing LSNs.

29. The product according to claim 28, wherein the instructions cause the one or more computers to roll-back the transaction request using the transaction entries recorded in the one or more log objects when the transaction request is not completed, so as to remove effects of the transaction request from the data structures.

30. The product according to claim 28, wherein responsively to a failure in the one of the computers handling the transaction request, the instructions cause another one of the computers to complete the transaction request, using the transaction entries recorded in the one or more log objects.
